(19) United States
(12) Patent Application Publication
(10) Pub. No.: US 2023/0120833 A1
(43) Pub. Date: Apr. 20, 2023

(54) SYSTEM AND METHOD FOR PREDICTING A PROPENSITY OF A USER TO INSTALL NON-INSTALLED APPLICATIONS

(71) Applicant: FLIPKART INTERNET PRIVATE LIMITED, Bengaluru (IN)

(72) Inventors: Ronit Hummer, Holon (IL); Shlomi Lifshits, Tel Aviv (IL)

(73) Assignee: FLIPKART INTERNET PRIVATE LIMITED, Bengaluru (IN)

(21) Appl. No.: 17/969,441

(22) Filed: Oct. 19, 2022

(30) Foreign Application Priority Data
Oct. 20, 2021 (IN) 202141047627

(51) Int. Cl. G06Q 40/02

(52) U.S. Cl. CPC G06Q 40/025

(57) ABSTRACT

A system and method for predicting a propensity of a user to install one or more non-installed applications. The method encompasses receiving, a first set of applications comprising application(s) installed on a user device and a pre-calculated matrix. The pre-calculated matrix comprises a pre-defined second set of applications comprising of one or more applications, and one or more application characteristics of all applications present in the pre-defined second set of applications. The method thereafter encompasses predicting, a propensity of the user to install the one or more non-installed applications from the one or more applications of the pre-defined second set of applications based on the first set of applications and the pre-calculated matrix.

### RELATED APPLICATION

This application claims priority under 35 U.S.C. § 119 to Indian Patent Application No. 202141047627, filed on Oct. 20, 2021, the entire contents of which are incorporated herein by reference.

### TECHNICAL FIELD

The present invention generally relates to propensity prediction and more particularly to systems and methods for predicting a propensity of a user to install one or more applications that are not installed in a user device.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With an immense growth in the field of digital technologies, it is now possible for digital platforms to provide users various recommendations such as a recommendation for a product may be provided over an e-commerce platform, a recommendation for a movie/media may be provided via a media and entertainment platform and the like. Further, for a particular user such recommendations are provided based on identification of a data related to the particular user. For instance, a data related to products purchased by a user in past may be used to provide to the user as recommendations one or more products similar to the products already purchased by said user. Also, in one another instance, a media may be recommended to a user based on a data related to a media service subscribed by said user.

Although various solutions have been developed over a period of time to provide the users various recommendations, but these currently known solutions are not efficient and effective in predicting a propensity of the users for one or more applications that are not installed in a user device of the users. Some of the currently known solutions provide the users one or more applications as recommendation but such applications related recommendations are not effective as the same are determined based on a description of the one or more applications and are not dependent on an indirect prediction of a propensity of the users for such applications. Furthermore, currently, there are no solutions present to determine the propensity of the users for the one or more applications that are not installed in the user device of such users, wherein such non installed applications may further be used to determine a creditworthiness of the users (i.e. an ability of the users for payment or non-payment of a loan).

Further, in order to determine the creditworthiness of the users some known solutions encompasses use of a snapshot of application(s) installed in the user device of the users. Furthermore, to identify the creditworthiness of the users these known solutions require a data related to the application(s) that are installed on the user device of the users, wherein said data may be a category of one or more applications installed on the user device, users’ usage data related to the one or more applications installed on the user device and/or the like. More particularly, these known solutions determine the creditworthiness of the users based on a count of applications (apps) of different categories (e.g., financial, social etc.) installed on the user device of such users, and/or based on detection of one or more specific apps installed on the user device of the user that are associated with a higher or lower risk of non-payment of a loan. There are many drawbacks to these previous solutions such as including but not limited to a fact that under a same category, there could be good apps that are associated with a lower credit risk, and as well as bad apps. In such cases there is no clear distinction between the two types of apps (i.e. the good apps and bad apps to predict creditworthiness) as they are all tagged under the same category. Also, generally the one or more specific apps that are used to determine the creditworthiness of the users are not very common and therefore using them may help to determine the creditworthiness of small groups of users but it fails to determine the creditworthiness of the rest of the users.

Also, some of the known solutions determine various parameters such as users’ personalities based on a usage of one or more applications by such users, recommendations based on a prediction of user interest from user’s installed application(s) insights, detection/prediction of life events of the users based on an application installation behavior of the users and the like, but these currently known solutions also fails to predict the propensity of the users for the one or more applications that are non-installed in the user device of said users, in order to further determine the creditworthiness of the users.

Therefore, there is a need in the art to provide a solution that can efficiently and effectively predict a propensity of a user for one or more applications that are not installed in a user device, for instance to further determine a creditworthiness of the user.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for predicting a propensity of a user for one or more applications that are not installed in a user device of the user. Also, an object of the present invention is to define a set of applications that may not be installed in the user device of users, wherein said set of applications is defined to predict a propensity of the users for one or more applications that are not installed in the user device of the users and are present in said set of applications. Further, an object of the present invention is to use an extension of Collaborative Filtering technique(s) for prediction of the propensity of the users for the one or more applications that are not-installed in the user device of the users, wherein in an implementation such extension of Collaborative Filtering technique(s) is suitable for cases where users do not directly rank a product and a preference for such product is predicted indirectly by the users’ actions with respect to the product. Also, an object of the present invention is to determine a creditworthiness of the users (i.e. a probability of a payment or a non-payment of a loan by the users) based on the prediction of the propensity of the users for the one or more non-installed applications. Another object of the present invention is to provide an efficient and effective alternative to requirement of at least one of a description of the application(s) installed in the user device of the users and one or more specific applications installed in the user device of the users, for determining the creditworthiness of the users. Also, an object of the present invention is to determine the creditworthiness of the users based on an application identifier of the one or more non-installed applications identified basis the propensity of the users determined for said one or more non-installed applications. Another object of the present invention is to identify a subset of non-installed application(s) for which a propensity prediction is highly useful to determine the creditworthiness of the users. Yet another object of the present invention is to categorize one or more users in one or more categories based on a respective predicted propensity of the one or more users for the one or more applications that are not installed in the user device of said one or more users.

Furthermore, in order to achieve the aforementioned objectives, the present invention provides a method and system for predicting a propensity of a user for one or more non-installed applications.

A first aspect of the present invention relates to the method for predicting a propensity of a user to install one or more non-installed applications. The method encompasses receiving, at a transceiver unit, a first set of applications comprising one or more applications installed by the user on a user device. The method thereafter comprises receiving, at the transceiver unit, a pre-calculated matrix, wherein the pre-calculated matrix comprises: a pre-defined second set of applications comprising of one or more applications, and one or more application characteristics of all the applications present in the pre-defined second set of applications. The method thereafter encompasses predicting, by a processing unit, a propensity of the user to install the one or more non-installed applications from the one or more applications of the pre-defined second set of applications based on the first set of applications and the pre-calculated matrix.

Another aspect of the present invention relates to a system for predicting a propensity of a user to install one or more non-installed applications. The system comprises a transceiver unit, configured to receive, a first set of applications comprising one or more applications installed by the user on a user device. The transceiver unit is also configured to receive, a pre-calculated matrix, wherein the pre-calculated matrix comprises: a pre-defined second set of applications comprising of one or more applications, and one or more application characteristics of all the applications present in the pre-defined second set of applications. The system further comprises a processing unit, configured to predict, a propensity of the user to install the one or more non-installed applications from the one or more applications of the pre-defined second set of applications based on the first set of applications and the pre-calculated matrix.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for predicting a propensity of a user to install one or more non-installed applications, in accordance with exemplary embodiments of the present invention.

FIG. 2 illustrates an exemplary method flow diagram [200], for predicting a propensity of a user to install one or more non-installed applications, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, a transceiver unit, an identification unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section the existing technologies have many limitations and in order to overcome at least some of the limitations of the prior known solutions, the present disclosure provides a solution for predicting a propensity of a user to install one or more applications that are not installed in a user device of said user. Also, the present invention provides a solution to predict one of a probability of payment of a loan and a probability of a non-payment of the loan by the user based on the propensity of the user to install each application from the one or more non-installed applications. More particularly, the present invention provides a solution for predicting one of the probability of payment of the loan and the probability of the non-payment of the loan by the user, where the user has enrolled or is about to enroll for a credit loan program from one or more digital platforms. Furthermore, based on the implementation of the features of the present invention, in an implementation where a user data available at the one or more digital platforms is not sufficient to effectively and efficiently determine a creditworthiness of the user (i.e. the probability of the payment of the loan and the probability of the non-payment of the loan by the user), the user is offered to give the one or more digital platforms an access to the user device of the user ( specifically to a list of installed applications on the user device), in order to assess the creditworthiness of the user. Further, once the permission to access to the user device of the user is received, one or more applications that are installed in the user device of the user are identified and a propensity of the user to install one or more applications is predicted based on a pre-calculated matrix. The one or more applications comprises at least one of one or more applications installed by the user on the user device and one or more applications that are not installed on the user device of the user. The pre-calculated matrix comprises: a pre-defined set of applications comprising of the one or more applications and one or more application characteristics of the one or more applications (i.e. all the applications present in the pre-defined set of applications). The propensity of the user to install each application is determined based on one or more Collaborative Filtering techniques. Also, the propensity of the user to install an application is highly interpretable expressing a predicted interest of the user in said application. Also, in an implementation, the propensity of the user to install an application that is not installed in the user device of such user is strongly associated with the user’s risk for defaulting. Furthermore, in an implementation, based on the implementation of the features of the present invention one or more users may be categorized in one or more categories in order to further target specific user segments based on a propensity of the one or more users to install one or more applications that are not installed on the user device of said one or more users.

Furthermore, the present invention provides a technical effect at least by predicting a propensity of a user to install one or more applications that are not installed in a user device of said user and by determining one of a probability of a payment of a loan and a probability of a non-payment of the loan by the user. Also, the present invention provides a technical advancement over the known solutions by indirectly predicting the propensity of the user for the one or more applications that are not installed in the user device of the user as the prior known solutions fails to indirectly predict the propensity of the one or more applications that are not installed in the user device of the user. Also, the present invention provides a technical advancement over the known solutions by determining one of the probability of the payment of the loan and the probability of the non-payment of the loan by the user based on the propensity of the user to install the one or more applications that are not installed in the user device of the user, wherein the prior known solutions have the limitation of using the applications that are installed in the user device for determining creditworthiness of user(s). Furthermore, as the present invention provides a solution that encompasses use of a user’s propensity for applications that are not installed in the user device, the present invention only requires an application identifier such as an application name of the one or more non-installed applications and no further application related data is required to determine the probability of the payment of the loan and the probability of the non-payment of the loan by the user. Therefore, the present invention overcomes the technical limitations related to at least one of a requirement of user usage data associated with application(s) installed in the user device, a requirement of an identification of a category of an application, a requirement of a description of an application and/or the like.

Hereinafter, exemplary embodiments of the present disclosure will be described in detail with reference to the accompanying drawings so that those skilled in the art can easily carry out the present disclosure.

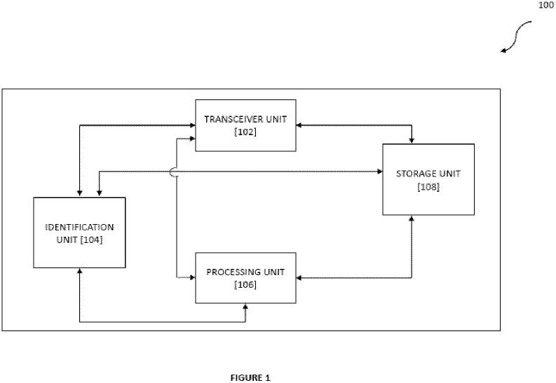

Referring to FIG. 1, an exemplary block diagram of a system [100] for predicting a propensity of a user for one or more non-installed applications is shown. The system [100] comprises at least one transceiver unit [102], at least one identification unit [104], at least one processing unit [106] and at least one storage unit [108]. Also, all of the components/ units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to predict a propensity of a user to install one or more non-installed applications, with the help of the interconnection between the components/units of the system [100].

The transceiver unit [102] of the system [100] is configured to receive, a first set of applications comprising one or more applications installed by the user on a user device. More particularly, a communication link between the system [100] and the user device is established via the transceiver unit [102] and once the communication link between the system [100] and the user device is established, the transceiver unit [102] is configured to receive from the user device, the first set of applications. The communication link between the system [100] and the user device may be a wired or wireless connection, via one or more networks, as may be known to persons skilled in the art. Furthermore, the first set of applications comprises the one or more applications installed by the user on the user device, i.e. the first set of applications comprises one or more applications that are manually installed by the user on the user device and the first set of applications does not include any application that is pre-installed on the user device. For instance, if in a user device a total of 50 applications are installed, wherein out of said 50 applications 30 applications are pre-installed and/or OEM applications and 20 applications are installed by a user basis his interest or requirements. In the given instance, the first set of application encompasses 20 applications that are manually installed by the user. Therefore, each application from the first set of application indicates one or more user’s preferences and a user behavior.

Also, the transceiver unit [102] is configured to receive, a pre-calculated matrix, wherein the pre-calculated matrix comprises: a pre-defined second set of applications comprising of one or more applications, and one or more application characteristics of the one or more applications (i.e. all the applications present in the pre-defined set of applications). The one or more applications present in the pre-calculated matrix comprises at least one of: one or more installed applications, and one or more non-installed applications. The one or more installed applications are one or more applications installed by the user on the user device and the one or more non-installed applications are one or more applications that are not installed on the user device. In an implementation, the pre-calculated matrix is determined based on a list of applications installed on a user device of a plurality of users associated with a digital platform. The digital platform may be an application over which a loan is to be provided to the user, for instance the digital platform may be an e-commerce application over which a user has availed a service to purchase a product via a loan facility (such as via a pay later facility). Also, in an example, in order to predict a propensity of a user A for one or more non-installed applications, a pre-calculated matrix comprising of a pre-defined second set of applications and one or more application characteristics of all the application of the pre-defined second set of applications may be received. In an instance the pre-defined second set of applications may comprise 4000 applications and said 4000 applications may be pre-selected from 20000 available applications based on a presence of said 4000 applications in a user device of 50,000 users associated with an e-commerce platform. Also, in the given example the e-commerce platform is an e-commerce application over which a loan facility is to be provided to the user A.

Thereafter, the processing unit [106] of the system [100] is configured to predict, a propensity of the user to install the one or more non-installed applications from the one or more applications of the pre-defined second set of applications based on the first set of applications and the pre-calculated matrix. More specifically, the processing unit [106] is configured to predict, the propensity of the user to install the one or more applications based on: the one or more applications installed by the user on the user device, the pre-defined second set of applications comprising of the one or more applications, and the one or more application characteristics of the one or more applications. In an example, if a first set of applications comprises 10 applications and if a pre-calculated matrix comprises 1000 applications along with one or more application characteristics of said 1000 applications. The processing unit [106] in the given example is configured to predict a propensity of a user to install one or more applications from the 1000 applications based on the 10 applications (i.e. the first set of applications), the 1000 applications (i.e. a pre-defined second set of applications comprising of 1000 applications) and the one or more application characteristics of said 1000 applications. Once the propensity of the user to install the one or more applications of the pre-defined second set of applications is predicted, the processing unit [106] is configured to predict the propensity of the user to install the one or more non-installed applications. More specifically, to predict the propensity of the user to install the one or more non-installed applications the processing unit [106] is thereafter configured to select based on the propensity of the user to install the one or more applications, at least one of a propensity of the user to install the one or more non-installed applications and a propensity of the user to install the one or more installed applications. More specifically, as the one or more applications comprises at least one of the one or more installed applications and the one or more non-installed applications, the propensity of the user to install the one or more applications comprises the propensity of the user to install at least one of the one or more installed applications and the one or more non-installed applications. Therefore, the processing unit [106] selects based on the propensity of the user to install the one or more applications, at least one of the propensities of the user to install the one or more non-installed applications and the propensity of the user to install the one or more installed applications.

Also, a propensity of the user to install each application from the one or more non-installed applications is further associated with one of a probability of payment of a loan and probability of a non-payment of the loan by the user. More particularly, as the selection of the pre-defined second set of applications from the plurality of applications is based on the identification of the one or more applications in the user device of the plurality of users associated with the digital platform, wherein the digital platform is the application over which the loan is to be provided to the user. Therefore, each application from the one or more applications of the pre-defined second set of applications is associated with a credit parameter, wherein such credit parameter indicates one of a payment of a loan and a non-payment of the loan by the plurality of users associated with the digital platform. The probability of payment of the loan and probability of the non-payment of the loan by the user is therefore also determined based on a propensity of the user for each application from the one or more non-installed applications.

Also, the processing unit [106] is further configured to determine a target set of applications from the one or more non-installed applications based on the credit parameter associated with each application in the one or more non-installed applications. In an implementation top N application with higher credit parameter are identified as the target set of applications from the one or more non-installed applications i.e. the top N applications indicating one of the payment of the loan and the non-payment of the loan by the plurality of users associated with the digital platform are identified as the target set of applications.

Also, in an implementation the identification unit [104] is further configured to identify one of a probability of the payment of the loan and a probability of the non-payment of the loan by the user based on a propensity of the user to install one or more applications from the target set of applications. More particularly, the identification unit [104] is configured to identify the probability of the payment of the loan and the probability of the non-payment of the loan by the user based on the propensity of the user for one or more applications from the top N applications with higher credit parameter (i.e. from the target set of applications). For example, if non-installed applications present in a pre-defined second set of applications comprises 1000 applications and a target set of applications is identified from the 1000 applications based on an identification of top 10 applications with higher credit parameter. The identification unit [104] in the given example is configured to identify one of the probabilities of the payment of the loan and the probability of the non-payment of the loan by the user based on the propensity of the user for the 10 applications identified as the target set of applications. More particularly, the identification unit [104] is configured to identify one of the probabilities of the payment of the loan and the probability of the non-payment of the loan by the user based on the propensity of the user to install the one or more applications from the target set of applications i.e. the top 10 applications with higher credit parameter.

Furthermore, the processing unit [106] is also configured to train a subsystem based on: a propensity of a plurality of users to install the one or more applications from the target set of applications, and at least one of a payment of a loan and a non-payment of a loan by a plurality of users of the digital platform which are associated with the target set of applications. In an implementation the subsystem is trained based on: a propensity of, a plurality of users of the digital platform, for the one or more applications from the target set of applications (wherein said propensity is determined based on the implementation of the features of the present invention); and at least one of the payment of the loan and the non-payment of a loan by the plurality of users of the digital platform which are associated with the target set of applications. Further the trained subsystem is configured to determine a creditworthiness of one or more customers/users of the digital platform.

In an implementation the processing unit [106] is also configured to categorize the user in one or more categories based on the propensity of the user to install the one or more non-installed applications. More particularly, the processing unit [106] is configured to identify one or more categories of the one more non-installed applications and thereafter the processing unit [106] is configured to categorize the user in such one or more categories based on a propensity of the user for the one or more applications associated with the one or more categories. For example, if a non-installed application A is categorized in a category 1 and a user propensity of a user 1 for the non-installed application A is highest, the user 1 in the given example is categorized in the category 1 basis the category of the non-installed application A.

Furthermore, the propensity of the user to install the one or more non-installed applications may further be used in multiple use cases and is not limited to determining the creditworthiness of the user and categorizing the user in one or more categories.

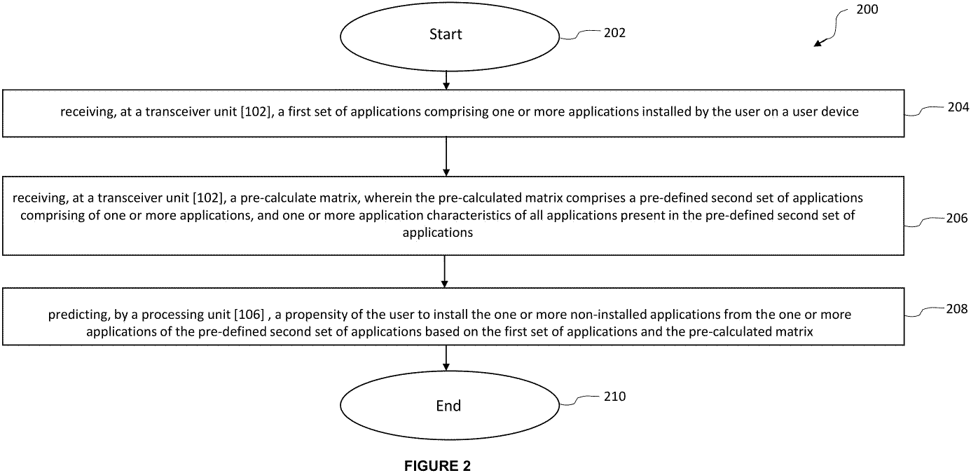

Referring to FIG. 2 an exemplary method flow diagram [200], for predicting a propensity of a user to install one or more non-installed applications, in accordance with exemplary embodiments of the present invention is shown. In an implementation the method is performed by the system [100]. Further, in an implementation, the system [100] may be present in a server device to implement the features of the present invention. Also, as shown in FIG. 2, the method starts at step [202].

At step [204] the method comprises receiving, at a transceiver unit [102], a first set of applications comprising one or more applications installed by the user on a user device. More particularly, a communication link between the system [100] and the user device is established via the transceiver unit [102] and once the communication link between the system [100] and the user device is established, the method encompasses receiving by the transceiver unit [102] from the user device, the first set of applications. The communication link between the system [100] and the user device may be a wired or wireless connection, via one or more networks, as may be known to persons skilled in the art. Furthermore, the first set of applications comprises the one or more applications installed by the user on the user device, i.e. the first set of applications comprises one or more applications that are manually installed by the user on the user device and the first set of applications does not include any application that is pre-installed on the user device. For instance, if in a user device a total of 100 applications are installed, wherein out of said 100 applications 70 applications are pre-installed and/or OEM applications and 30 applications are installed by a user basis his interest or requirements. In the given instance, the first set of application encompasses 30 applications that are manually installed by the user. Therefore, each application from the first set of application indicates one or more user’s preferences and a user behavior.

Next at step [206] the method comprises receiving, at the transceiver unit [102], a pre-calculated matrix, wherein the pre-calculated matrix comprises: a pre-defined second set of applications comprising of one or more applications, and one or more application characteristics of the one or more applications (i.e. all the applications present in the pre-defined set of applications). The one or more applications present in the pre-calculated matrix comprises at least one of: one or more installed applications, and one or more non-installed applications. The one or more installed applications are one or more applications installed by the user on the user device and the one or more non-installed applications are one or more applications that are not installed on the user device. In an implementation, the pre-calculated matrix is determined based on a list of applications installed on a user device of a plurality of users associated with a digital platform. The digital platform may be an application over which a loan is to be provided to the user, for instance the digital platform may be an e-commerce application over which a user has availed a service to purchase a product via a loan facility (such as via a pay later facility). Also, in an example, in order to predict a propensity of a user 1 for one or more non-installed applications, a pre-calculated matrix comprising of a pre-defined second set of applications and one or more application characteristics of all the application of the pre-defined second set of applications may be received., In an instance the pre-defined second set of applications may comprise 5000 applications, wherein said 5000 applications may be pre-selected from 100000 available applications based on a presence of said 5000 applications in a user device of 40,000 users associated with an e-commerce platform. Also, in the given example the e-commerce platform is an e-commerce application over which a loan facility is to be provided to the user 1.

Further, at step [208] the method comprises predicting, by a processing unit [106], a propensity of the user to install the one or more non-installed applications from the one or more applications of the pre-defined second set of applications based on the first set of applications and the pre-calculated matrix. The one or more applications further comprises at least one of the one or more installed applications and the one or more non-installed applications. More specifically, the method encompasses predicting by the processing unit [106], the propensity of the user to install the one or more applications based on: the one or more applications installed by the user on the user device, the pre-defined second set of applications comprising of the one or more applications, and the one or more application characteristics of the one or more applications. In an example, if a first set of applications comprises 50 applications and if a pre-calculated matrix comprises 5000 applications along with one or more application characteristics of said 5000 applications. The method in the given example comprises predicting by the processing unit [106], a propensity of a user to install one or more applications from the 5000 applications based on the 50 applications (i.e. the first set of applications), the 5000 applications (i.e. a pre-defined second set of applications comprising of 5000 applications) and the one or more application characteristics of said 5000 applications. Once the propensity of the user to install the one or more applications of the pre-defined second set of applications is predicted, the method encompasses selecting, by the processing unit [106], based on the propensity of the user to install the one or more applications, at least one of a propensity of the user to install the one or more non-installed applications and a propensity of the user to install the one or more installed applications. More specifically, as the one or more applications comprises at least one of the one or more installed applications and the one or more non-installed applications, the propensity of the user to install the one or more applications comprises the propensity of the user to install at least one of the one or more installed applications and the one or more non-installed applications. Therefore, the method encompasses predicting the propensity of the user to install the one or more non-installed applications by selecting by the processing unit [106], from the propensity of the user to install the one or more applications, at least the propensity of the user to install the one or more non-installed applications.

Also, a propensity of the user to install each application from the one or more non-installed applications is further associated with one of a probability of payment of a loan and probability of a non-payment of the loan by the user. More particularly, as the pre-selection of the pre-defined second set of applications from the plurality of applications is based on the identification of the one or more applications in the user device of the plurality of users associated with the digital platform, wherein the digital platform is the application over which the loan is to be provided to the user. Therefore, each application from the one or more applications of the pre-defined second set of applications is associated with a credit parameter, wherein such credit parameter indicates one of a payment of a loan and a non-payment of the loan by the plurality of users associated with the digital platform. The probability of payment of the loan and probability of the non-payment of the loan by the user is therefore also determined based on preference propensity of the user for each application from the one or more non-installed applications.

Also, the method comprises determining by the processing unit [106], a target set of applications from the one or more non-installed applications based on the credit parameter associated with the each application in the one or more non-installed applications. In an implementation top N application with higher credit parameter are identified as the target set of applications from the one or more non-installed applications i.e. the top N applications indicating one of the payment of the loan and the non-payment of the loan by the plurality of users associated with the digital platform are identified as the target set of applications.

Also, in an implementation method further comprises identifying by the identification unit [104], one of a probability of the payment of the loan and a probability of the non-payment of the loan by the user based on a propensity of the user to install one or more applications from the target set of applications. More particularly, the method encompasses identifying by the identification unit [104], the probability of the payment of the loan and the probability of the non-payment of the loan by the user based on the propensity of the user for one or more applications from the top N applications with higher credit parameter (i.e. from the target set of applications). For example, if non-installed applications present in a pre-defined second set of applications comprises 4000 applications and a target set of applications is identified from the 4000 applications based on an identification of top 20 applications with higher credit parameter. The method in the given example identifies one of the probabilities of the payment of the loan and the probability of the non-payment of the loan by the user based on the propensity of the user for the 20 applications identified as the target set of applications. More particularly, the method identifies one of the probabilities of the payment of the loan and the probability of the non-payment of the loan by the user based on the propensity of the user to install the one or more applications from the target set of applications i.e. the top 20 applications with higher credit parameter.

Furthermore, the method also comprises training by the processing unit [106], a subsystem based on: a propensity of a plurality of users to install the one or more applications from the target set of applications, and at least one of a payment of a loan and a non-payment of a loan by a plurality of users of the digital platform which are associated with the target set of applications. In an implementation the subsystem is trained based on: a propensity of, a plurality of users of the digital platform, for the one or more applications from the target set of applications (wherein said propensity is determined based on the implementation of the features of the present invention); and at least one of the payment of the loan and the non-payment of the loan by the plurality of users of the digital platform which are associated with the target set of applications. Further the trained subsystem is configured to determine a creditworthiness of one or more customers/users of the digital platform.

In an implementation the method also comprises categorizing by the processing unit [106], the user in one or more categories based on the propensity of the user to install the one or more non-installed applications. More particularly, the method encompasses identifying by the processing unit [106] one or more categories of the one more non-installed applications and thereafter the method comprises categorizing by the processing unit [106] the user in such one or more categories based on a propensity of the user for the one or more applications associated with the one or more categories. For example, if a non-installed application Z is categorized in a category A and a user propensity of a user 1 for the non-installed application Z is highest, the user 1 in the given example is categorized in the category A basis the category of the non-installed application Z.

After determining one of the probabilities of the payment of the loan and the probability of the non-payment of the loan by the user based on prediction of the propensity of the user for the one or more non-installed applications, the method terminates at step [210].

Furthermore, the propensity of the user to install the one or more non-installed applications may further be used in multiple use cases and is not limited to determining the creditworthiness of the user and categorizing the user in one or more categories.

Thus, the present invention provides a novel solution for predicting a propensity of a user to install one or more non-installed applications. Also, the present invention provides a technical effect at least by predicting a propensity of a user for one or more applications that are not installed in a user device of said user and by determining one of a probability of a payment of a loan and a probability of a non-payment of the loan by the user. Also, the present invention provides a technical advancement over the known solutions by indirectly predicting the propensity of the user for the one or more applications that are not installed in the user device of the user as the prior known solutions fails to indirectly predict the propensity of the one or more applications that are not installed in the user device of the user. Also, the present invention provides a technical advancement over the known solutions by determining one of the probability of the payment of the loan and the probability of the non-payment of the loan by the user based on the propensity of the user to install the one or more applications that are not installed in the user device of the user, wherein the prior known solutions has the limitation of using the application that are installed in the user device for determining creditworthiness of user(s). Furthermore, as the present invention provides a solution that encompasses use of a user’s propensity for applications that are not installed in the user device, the present invention only requires an application identifier such as an application name of the one or more non-installed applications and no further application related data is required to determine the probability of the payment of the loan and the probability of the non-payment of the loan by the user. Therefore, the present invention overcomes the technical limitations related to at least of a requirement of user usage data associated with application(s) installed in the user device, a requirement of an identification of a category of an application, a requirement of a description of an application and/or the like.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

What is claimed is:

1. A method for predicting a propensity of a user to install one or more non-installed applications, the method comprising:
receiving, at a transceiver unit [102], a first set of applications comprising one or more applications installed by the user on a user device;
receiving, at the transceiver unit [102], a pre-calculated matrix, wherein the pre-calculated matrix comprises:
a pre-defined second set of applications comprising of one or more applications, and
one or more application characteristics of all applications present in the pre-defined second set of applications; and
predicting, by a processing unit [106], a propensity of the user to install the one or more non-installed applications from the one or more applications of the pre-defined second set of applications based on the first set of applications and the pre-calculated matrix.

2. The method as claimed in claim 1, wherein the one or more non-installed applications are one or more applications that are not installed on the user device.

3. The method as claimed in claim 1, the method further comprises categorizing by the processing unit [106], the user in one or more categories based on the propensity of the user to install the one or more non-installed applications.

4. The method as claimed in claim 1, wherein a propensity of the user to install each application from the one or more non-installed applications is further associated with one of a probability of payment of a loan and probability of a non-payment of the loan by the user.

5. The method as claimed in claim 1, the method further comprises determining by the processing unit [106], a target set of applications from the one or more non-installed applications based on a credit parameter associated with each application from the one or more non-installed applications, wherein the credit parameter indicates one of a payment of a loan and a non-payment of the loan by a plurality of users.

6. The method as claimed in claim 5, the method further comprises identifying by an identification unit [104], one of a probability of the payment of the loan and a probability of the non-payment of the loan by the user based on a propensity of the user to install one or more applications from the target set of applications.

7. The method as claimed in claim 6, the method further comprises training by the processing unit [106], a subsystem based on: a propensity of a plurality of users to install the one or more applications from the target set of applications, and a payment of a loan and a non-payment of a loan by a plurality of users associated with the target set of applications.

8. A system for predicting a propensity of a user to install one or more non-installed applications, the system comprising:
a transceiver unit [102], configured to:
receive, a first set of applications comprising one or more applications installed by the user on a user device, and
receive, a pre-calculated matrix, wherein the pre-calculated matrix comprises:
a pre-defined second set of applications comprising of one or more applications, and
one or more application characteristics of all applications present in the pre-defined second set of applications; and
a processing unit [106], configured to predict, a propensity of the user to install the one or more non-installed applications from the one or more applications of the pre-defined second set of applications based on the first set of applications and the pre-calculated matrix.

9. The system as claimed in claim 8, wherein the one or more non-installed applications are one or more applications that are not installed on the user device.

10. The system as claimed in claim 8, wherein the processing unit [106] is further configured to categorize the user in one or more categories based on the propensity of the user to install the one or more non-installed applications.

11. The system as claimed in claim 8, wherein a propensity of the user to install each application from the one or more non-installed applications is further associated with one of a probability of payment of a loan and probability of a non-payment of the loan by the user.

12. The system as claimed in claim 8, wherein the processing unit [106] is further configured to determine a target set of applications from the one or more non-installed applications based on a credit parameter associated with each application in the one or more non-installed applications, wherein the credit parameter indicates one of a payment of a loan and a non-payment of the loan by a plurality of users.

13. The system as claimed in claim 12, the system further comprises an identification unit [104] configured to identify one of a probability of the payment of the loan and a probability of the non-payment of the loan by the user based on a propensity of the user to install one or more applications from the target set of applications.

14. The system as claimed in claim 13, wherein the processing unit [106] is further configured to train a subsystem based on: a propensity of a plurality of users to install the one or more applications from the target set of applications, and a payment of a loan and a non-payment of a loan by a plurality of users associated with the target set of applications.
